(19) United States
(12) Patent Application Publication
(10) Pub. No.: US 2022/0097294 A1
(43) Pub. Date: Mar. 31, 2022

(54) 3D PRINTER DEVICE, MANUFACTURING METHOD OF THREE-DIMENSIONAL STRUCTURE, AND THREE-DIMENSIONAL STRUCTURE

(71) Applicant: SONY GROUP CORPORATION, TOKYO (JP)

(72) Inventor: SHUNICHI SUWA, TOKYO (JP)

(21) Appl. No.: 17/310,663

(22) PCT Filed: Jan. 30, 2020
(86) PCT No.: PCT/JP2020/003468

§ 371 Date: Aug. 16, 2021

(30) Foreign Application Priority Data
Feb. 26, 2019 (JP) 2019-033131

(51) Int. Cl. B29C 64/129; B29C 64/268; B29C 64/314; B33Y 10/00; B33Y 30/00; B33Y 40/10

(52) U.S. Cl. CPC B29C 64/129; B29C 64/268; B29C 64/314; B29K 2995/0044; B33Y 30/00; B33Y 40/10; B29K 2995/0006; B33Y 10/00

(57) ABSTRACT

To provide a 3D printer device capable of manufacturing a three-dimensional structure in which a physical property of the three-dimensional structure is freely controlled. Provided is a 3D printer device at least provided with a three-dimensional structure forming liquid for forming a three-dimensional structure, a bath that accommodates the three-dimensional structure forming liquid, and an electrode, in which the electrode is arranged on a bottom surface of the bath.

### TECHNICAL FIELD

The present technology relates to a 3D printer device, and more specifically, this relates to a 3D printer device, a manufacturing method of a three-dimensional structure, and a three-dimensional structure.

### BACKGROUND ART

In recent years, various materials are proposed and commercialized for a 3D printer. Generally, they are organic materials (polymer resins), but an inorganic material (glass) and a metal material are also proposed.

For example, a manufacturing method of a three-dimensional structure for manufacturing a three-dimensional structure using a plurality of types of resin materials is proposed (refer to Patent Document 1).

Furthermore, for example, a manufacturing method of a three-dimensional structure for manufacturing a three-dimensional structure using an oriented material is proposed (refer to Patent Document 2).

### CITATION LIST

### Patent Document

Patent Document 1: Japanese Patent Application Laid-Open No. 2017-25187

Patent Document 2: Japanese Patent Application Laid-Open No. 2016-117273

### SUMMARY OF THE INVENTION

### Problems to be Solved by the Invention

However, the technologies proposed in Patent Documents 1 and 2 might not be able to freely control a physical property of a three-dimensional structure.

Therefore, the present technology is achieved in view of such circumstances, and a principal object thereof is to provide a 3D printer device capable of manufacturing a three-dimensional structure in which a physical property of the three-dimensional structure is freely controlled, a manufacturing method of a three-dimensional structure in which a physical property of the three-dimensional structure may be freely controlled, and a three-dimensional structure in which a physical property of the three-dimensional structure is freely controlled.

### Solutions to Problems

As a result of earnest research to solve the above-described problem, the present inventor has succeeded in freely controlling a physical property of a three-dimensional structure, and has completed the present technology.

That is, the present technology provides

a 3D printer device at least provided with:

a three-dimensional structure forming liquid for forming a three-dimensional structure;

a bath that accommodates the three-dimensional structure forming liquid; and an electrode, in which

the electrode is arranged on a bottom surface of the bath.

In the 3D printer device according to the present technology,

at least two of electrodes may be arranged on the bottom surface of the bath,

an electric field may be generated between the at least two electrodes,

an interval between the at least two electrodes may be not smaller than 0.1 μm and not larger and 100 μm,

an electrode width of each of the at least two electrodes may be not smaller than 0.1 μm and not larger than 100 μm, and

the at least two electrodes may be comb-shaped electrodes.

In the 3D printer device according to the present technology,

at least two electrode layers may be arranged on the bottom surface of the bath,

an electric field may be generated between the at least two electrode layers,

then, the at least two electrode layers may be stacked,

in this stacked configuration, an upper electrode layer may be patterned,

by this patterning, the upper electrode layer may have a slit structure,

the slit structure may include a plurality of slits,

an interval between at least two slits of the plurality of slits may be not smaller than 0.1 μm and not larger than 100 μm, and

a width of a slit of the upper electrode layer may be not smaller than 0.1 μm and not larger than 100 μm.

In the 3D printer device according to the present technology,

the electrode may be a transparent electrode.

The 3D printer device according to the present technology may be provided with a flattening layer, in which the electrode may be formed in the flattening layer.

Furthermore, the 3D printer device according to the present technology may further be provided with a surface treated layer formed on the flattening layer.

In the 3D printer device according to the present technology,

an active element may be installed on the electrode.

Furthermore, the present technology provides

a manufacturing method of a three-dimensional structure provided with:

forming a layer at least containing molecules and/or particles, and aligning the molecules and/or the particles by applying an electric field, in which

the forming the layer containing the molecules and/or the particles and the aligning the molecules and/or the particles by applying the electric field are repeated a plurality of times.

In the manufacturing method of a three-dimensional structure according to the present technology,

the molecules and/or the particles may have dielectric anisotropy, and the molecule and/or the particle may express ferroelectricity.

In the manufacturing method of a three-dimensional structure according to the present technology,

the layer may contain a resin material, and

the manufacturing method may be provided with forming a layer while performing temperature control on the resin material not yet cured out of the resin material.

In the manufacturing method of a three-dimensional structure according to the present technology,

by using an electrode arranged on a bottom surface of a bath that accommodates a three-dimensional structure forming liquid for forming a three-dimensional structure, the electrode capable of applying an electric field to the bottom surface,

it is possible to selectively cure at least a part of the layer in a state in which the electric field is not applied, and thereafter cure a portion other than at least a part of the layer in a state in which the electric field is applied.

In the manufacturing method of a three-dimensional structure according to the present technology,

by using an electrode arranged on a bottom surface of a bath that accommodates a three-dimensional structure forming liquid for forming a three-dimensional structure, the electrode capable of selectively applying an electric field to at least a part of the bottom surface,

it is possible to cure an entire layer in a state in which the electric field is selectively applied to at least a part of the layer.

Moreover, the present technology provides a three-dimensional structure obtained by the manufacturing method of a three-dimensional structure according to the present technology, especially, the manufacturing method of a three-dimensional structure according to the present technology provided with: by using an electrode arranged on a bottom surface of a bath that accommodates a three-dimensional structure forming liquid for forming a three-dimensional structure, the electrode capable of applying an electric field to an entire bottom surface, selectively curing at least a part of the layer in a state in which the electric field is not applied, and thereafter curing a portion other than the at least a part of the layer in a state in which the electric field is applied,

the three-dimensional structure having an arbitrary molecular orientation direction and/or an arbitrary particle orientation direction for each region of the layer,

provides a three-dimensional structure having an arbitrary molecular orientation direction and/or an arbitrary particle orientation direction for each region of the layer, and including a non-oriented region,

provides a three-dimensional structure provided with:

a first region including a first molecule and/or a first particle, and a second region including a second molecule and/or a second particle, in which

a first electric field is applied to the first region,

a second electric field is applied to the second region, and

a molecular orientation direction of the first molecule and/or a particle orientation direction of the first particle is different from a molecular orientation direction of the second molecule and/or a particle orientation direction of the second particle, and

provides a three-dimensional structure provided with:

a first region including a first molecule and/or a first particle, and a second region including a second molecule and/or a second particle, in which

a first electric field is applied to the first region,

a second electric field is applied to the second region, and

an angle between the molecular orientation direction of the first molecule and/or the particle orientation direction of the first particle and the molecular orientation direction of the second molecule and/or the particle orientation direction of the second particle is substantially 90 degrees.

Moreover, the present technology provides a three-dimensional structure obtained by the manufacturing method of a three-dimensional structure according to the present technology, especially, the manufacturing method of a three-dimensional structure according to the present technology provided with: by using an electrode arranged on a bottom surface of a bath that accommodates a three-dimensional structure forming liquid for forming a three-dimensional structure, the electrode capable of selectively applying an electric field to at least a part of the bottom surface, curing an entire layer in a state in which the electric field is selectively applied to at least a part of the layer,

the three-dimensional structure having an arbitrary molecular orientation direction and/or an arbitrary particle orientation direction for each region of the layer,

provides a three-dimensional structure having an arbitrary molecular orientation direction and/or an arbitrary particle orientation direction for each region of the layer, and including a non-oriented region,

provides a three-dimensional structure provided with:

a first region including a first molecule, and a second region including a second molecule, in which

a first electric field is applied to the first region,

a second electric field is applied to the second region, and

a molecular orientation direction of the first molecule and/or a particle orientation direction of the first particle is different from a molecular orientation direction of the second molecule and/or a particle orientation direction of the second particle, and

provides a three-dimensional structure provided with:

a first region including a first molecule and/or a first particle, and a second region including a second molecule and/or a second particle, in which

a first electric field is applied to the first region,

a second electric field is applied to the second region, and

an angle between the molecular orientation direction of the first molecule and/or the particle orientation direction of the first particle and the molecular orientation direction of the second molecule and/or the particle orientation direction of the second particle is substantially 90 degrees.

According to the present technology, a physical property of a three-dimensional structure may be freely controlled. Note that, the effects herein described are not necessarily limited and may be any of the effects described in the present disclosure or effects different from them.

### BRIEF DESCRIPTION OF DRAWINGS

FIG. 1 is a view illustrating a configuration example of a 3D printer device to which the present technology is applied.

FIG. 2 is a view for illustrating that a layer is formed while molecules are aligned by application of an electric field generated between two electrodes.

FIG. 3 is a view for illustrating an interval between the two electrodes and an electrode width.

FIG. 4 is a view illustrating a configuration example of a comb-shaped electrode.

FIG. 5 is a view for illustrating that the layer is formed while molecules are aligned by application of an electric field generated between two electrode layers.

FIG. 6 is a view for illustrating that the electrode is formed in a flattening layer.

FIG. 7 is a view for illustrating that a surface treated layer is formed on the flattening layer.

FIG. 8 is a view for illustrating a manufacturing method of a three-dimensional structure to which the present technology is applied.

FIG. 9 is a view for illustrating a manufacturing method of a three-dimensional structure to which the present technology is applied.

FIG. 10 is a view illustrating a configuration example of a three-dimensional structure to which the present technology is applied.

FIG. 11 is a view illustrating a configuration example of an electrode and an active element installed on the electrode.

FIG. 12 is a view illustrating a configuration example of an electrode and an active element installed on the electrode.

### MODE FOR CARRYING OUT THE INVENTION

Hereinafter, a preferred mode for carrying out the present technology is described. An embodiment hereinafter described illustrates an example of a representative embodiment of the present technology, and the scope of the present technology is not narrowed by this. Note that, in the drawings, the same or equivalent elements or members are assigned with the same reference numeral, and the description thereof is not repeated.

Furthermore, unless otherwise specified, in the drawings, “upper” means an upward direction or an upper side in the drawing, “lower” means a downward direction or a lower side in the drawing, “left” means a leftward direction or a left side in the drawing, and “right” means a rightward direction or a right side in the drawing.

Note that, the description is given in the following order.

1. Outline of Present Technology

2. First Embodiment (Example of 3D Printer Device)

3. Second Embodiment (Example of Manufacturing Method of Three-Dimensional Structure)

4. Third Embodiment (Example of Three-Dimensional Structure)

### 1. Outline of Present Technology

First, an outline of the present technology is described.

The present technology focuses on a molecular structure and/or a particle structure inside a three-dimensional structure (inside a molded object), freely controls a physical property of the three-dimensional structure (molded object), and further expands the physical property.

The present technology is the invention of an aligning method of aligning molecules and/or particles when performing 3D printing by a stereolithography apparatus (SLA). It is possible to align materials having dielectric anisotropy and the like by arranging an electrode on a bottom surface of a bath of a suspension system among the SLA, and applying an electric field. By applying light that cures a resin in this state, a layer in which the molecules and/or particles are aligned in the same direction may be formed. After that, by repeating pull-up, electric field application, and photocuring, a three-dimensional structure (solid structure) may be created.

Moreover, by making a portion photocured in a state in which no electric field is applied and a portion photocured in a state in which the electric field is applied, molecular and/or particle orientation distribution in a horizontal direction in the three-dimensional structure (solid structure) may be made. In this case, as a light source, it is possible to scan with laser light and the like capable of selecting a location to be cured, or to selectively irradiate the location by a projector system. That is, the light source, an irradiation system and the like are not especially limited as long as a method allows selective irradiation. A portion irradiated with light is the portion in which the three-dimensional structure is formed, and a portion not irradiated with the light is the portion in which the three-dimensional structure is not formed. Therefore, unless the three-dimensional structure such as a cube and a rectangular parallelepiped is manufactured, it is often impossible to collectively expose an entire surface.

Moreover, by adding an active element (for example, a TFT element) to the electrode arranged on the bottom surface of the bath, it is possible to make the molecular and/or particle orientation distribution in the horizontal direction in the three-dimensional structure (solid structure). In this case, since all in-plane molecular and/or particle orientation states are determined, as a light source, collective exposure by a projector and the like is possible, and collective exposure by laser light using a galvanometer mirror, a MEMS mirror and the like is also possible. That is, the light source, the irradiation system and the like are not especially limited as long as a method allows the collective exposure. A portion irradiated with light is the portion in which the three-dimensional structure is formed, and a portion not irradiated with the light is the portion in which the three-dimensional structure is not formed. Therefore, unless the three-dimensional structure such as a cube and a rectangular parallelepiped is manufactured, it is often impossible to collectively expose an entire surface. In the collective exposure, it is not required to expose in two steps when forming the same layer, for example, to expose without applying the electric field and then expose again while applying the electric field.

According to the present technology, it is possible to freely control the physical property of the three-dimensional structure, and in further detail, it is possible to freely control physical values such as heat, light, and dynamics of the three-dimensional structure in a three-dimensional manner by aligning the molecules and/or particles, thereby expressing anisotropy to manufacture an unprecedented material. Note that, aligning the molecules means making directions of the physical properties of the molecules uniform, and moreover, aligning the particles means making directions of the physical properties of the particles uniform.

Hereinafter, embodiments according to the present technology are specifically described in detail.

### 2. First Embodiment (Example of 3D Printer Device)

A 3D printer device of a first embodiment (an example of a 3D printer device) according to the present technology is a 3D printer device at least provided with a three-dimensional structure forming liquid for forming a three-dimensional structure, a bath that accommodates the three-dimensional structure forming liquid, and an electrode, in which the electrode is arranged on a bottom surface of the bath.

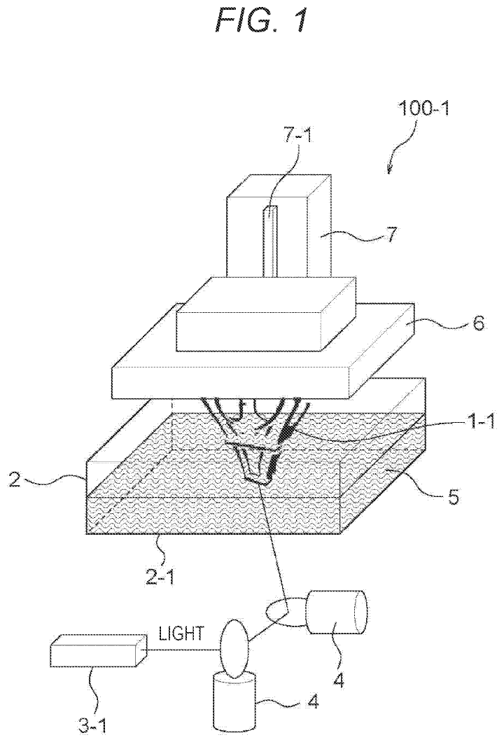

Among many 3D printers, the 3D printer device of the first embodiment according to the present technology focuses on a “suspension system” in a stereolithography apparatus (SLA) (there are a “free liquid level system” and a “suspension system” regarding a direction in which layers are stacked, and a “laser scanning system” and “surface exposure (projector) system” as an exposure system for forming the layer in the stereolithography apparatus (SLA)) (for example, FIG. 1). Any of the exposure systems may be applied, but methods become different, so that they are described later.

The “suspension system” in the stereolithography apparatus (SLA) is characterized that a formed layer is always in contact with the bottom surface of a resin bath (each time). Compared with the free liquid level system, this has an advantage of being able to precisely control a layer thickness and to prevent polymerization inhibition due to oxygen because oxygen does not come into contact with a resin surface to be cured, so that a mainstream of the SLA is recently changing from the free liquid level system to the suspension system. Furthermore, in the free liquid level system, the formed layer is always in contact with an air (N2) interface as compared with the suspension system.

The present technology focuses on a characteristic that the formed layer in the suspension system is always in contact with the bottom surface of the bath (resin bath) (each time). By arranging the electrode on the bottom surface of the bath (resin bath), it is possible to apply an electric field to the formed layer each time the layer is formed. Therefore, by adding molecules and particles directions of which are made uniform by the electric field as a resin, a molded object (three-dimensional structure) may express various types of anisotropy.

FIG. 1 is a configuration example of the 3D printer device to which the present technology is applied, and in further detail, this is a view illustrating a 3D printer device 100-1 of the first embodiment according to the present technology.

The 3D printer device 100-1 includes a bath 2 that accommodates a three-dimensional structure forming liquid 5 for forming a three-dimensional structure 1-1, a laser 3-1, two galvanometer mirrors 4, a stage 6, a vertical motion drive device 7 provided with a vertical motion drive unit 7-1, and an electrode (not illustrated) arranged on a bottom surface 2-1 of the bath 2. The three-dimensional structure forming liquid 5 may be an uncured resin (polymer) or a monomer liquid. Furthermore, the three-dimensional structure forming liquid 5 may contain a photopolymerization initiator.

The 3D printer device 100-1 is of the suspension system by the vertical motion drive device 7 provided with the vertical motion drive unit 7-1, in which light output from the laser 3-1 is reflected by the galvanometer mirrors 4-1 to be applied for forming a layer (a layer forming the three-dimensional structure 1-1) from the bottom surface of the bath 2. That is, the bottom surface (a surface on which one layer of uncured resin is prepared) of the bath 2 is scanned with the laser 3-1. When the layer (the layer forming the three-dimensional structure 1-1) is formed, the stage 6 is pulled up and the uncured resin enters between the bottom surface and a cured resin layer (the layer forming the three-dimensional structure 1-1). Then, the light for forming the layer (the layer forming the three-dimensional structure 1-1) is applied again.

In the 3D printer device of the first embodiment according to the present technology, at least two electrodes may be arranged on the bottom surface of the bath, and in this case, an electric field is generated between the at least two electrodes.

The at least two electrodes may be a positive electrode and a negative electrode, or an electric field may be generated between two or more electrodes by application of an alternating current.

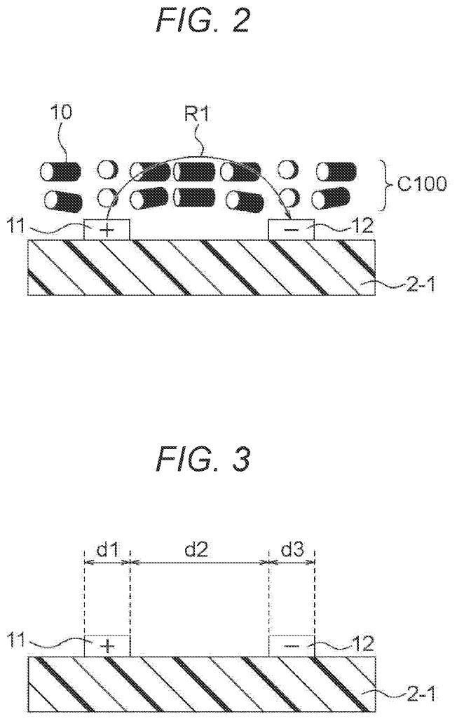

FIG. 2 is a view for illustrating that the layer is formed while molecules are aligned by application of the electric field generated between two electrodes. Note that, FIG. 2 may be applied not only to molecules but also to particles. As illustrated in FIG. 2, between a positive electrode 11 and a negative electrode 12 arranged on the bottom surface 2-1 of the bath 2, the electric field (line of electric force R1, transverse electric field) is generated, molecules 10 are aligned, and a layer C100 is formed. Note that, when the alternating current is applied, the positive electrode 11 may become a negative electrode, and the negative electrode 12 may become a positive electrode.

In the 3D printer device of the first embodiment according to the present technology, an interval between the at least two electrodes may be arbitrary, but this is preferably not smaller than 0.1 μm and not larger than 100 μm, and an electrode width of each of the at least two electrodes may also be arbitrary, but this is preferably not smaller than 0.1 μm and not larger than 100 μm.

As described above, design values of the electrode width and the electrode interval are limited as a preferable mode, but a lower limit (0.1 μm) may be set in consideration of processing resolution of a laser repair machine and the like. In a case where the electrode is processed by photolithography, this is coarser and about 2 μm. Regarding an upper limit (100 μm), resolution in XY directions of a current general 3D printer (SLA) is taken into consideration. By the way, various 3D printers are commercialized, but most of them have the resolution of 100 μm.

FIG. 3 is a view for illustrating the interval between the two electrodes and the electrode width. As illustrated in FIG. 3, the positive electrode 11 and the negative electrode 12 are arranged on the bottom surface 2-1 of the bath 2. In FIG. 3, the electrode width of the positive electrode 11 is d1, the electrode width of the negative electrode 12 is d3, and the electrode interval between the positive electrode 11 and the negative electrode 12 is d2. For example, the electrode width d1 of the positive electrode 11 is not smaller than 0.1 μm and not larger than 100 μm as a preferable mode, the electrode width d3 of the negative electrode 12 is not smaller than 0.1 μm and not larger than 100 μm as a preferred mode, and the electrode interval d2 between the positive electrode 11 and the negative electrode 12 is not smaller than 0.1 μm and not larger than 100 μm as a preferable mode.

A design example of the electrode arranged on the bottom surface of the bath includes a comb-shaped electrode. By arranging the comb-shaped electrodes as a repeating pattern over a certain range, directions of anisotropic materials within a certain range may be made uniform.

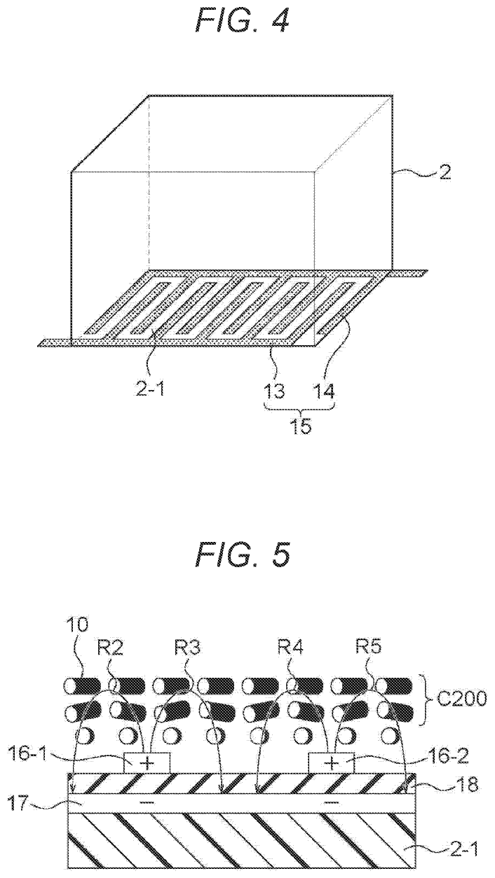

FIG. 4 is a view illustrating a configuration example of the comb-shaped electrode. As illustrated in FIG. 4, a comb-shaped electrode 15 is arranged on the bottom surface 2-1 of the bath 2. The comb-shaped electrode 15 includes, for example, a positive electrode 13 and a negative electrode 14.

As a design of the electrode for generating the electric field (for example, transverse electric field), the electrode may have a two-layer stacked structure. Note that, the stacked structure may have three or more stacked layers while making a layered structure of the electrodes. For example, it is possible to generate the electric field between upper and lower electrodes by making the lower electrode a solid surface electrode and slitting the upper electrode. At that time, the electric field is generated between the upper and lower electrodes, and the electric field (for example, transverse electric field) is generated in an upper layer of the electrode in which there is a layer to be formed (for example, the resin layer). It is sufficient that a layer between the upper and lower electrodes is, for example, an insulating layer, and this is preferably a hard film of an inorganic material. This is because a short circuit between the upper and lower electrodes due to mixing of a foreign matter may be prevented.

FIG. 5 is a view for illustrating that the layer is formed while molecules are aligned by application of the electric field generated between two electrode layers.

In FIG. 5, a solid surface electrode (negative electrode) 17 is arranged as the lower electrode on the bottom surface 2-1 of the bath 2, an insulating layer 18 is arranged on the solid surface electrode (negative electrode) 17, and slit-shaped electrodes 16-1 and 16-2 (positive electrodes) are arranged as the upper electrodes on the insulating layer 18. Note that, FIG. 5 may be applied not only to molecules but also to particles. As illustrated in FIG. 5, the electric field (lines of electric force R2 and R3, transverse electric field) is generated between the slit-shaped electrode (positive electrode) 16-1 and the solid surface electrode (negative electrode) 17, then the electric field (lines of electric force R4 and R5, transverse electric field) is generated between the slit-shaped electrode (positive electrode) 16-2 and the solid surface electrode (negative electrode) 17, the molecules 10 are aligned, and a layer C200 is formed.

When the upper electrode has a slit shape, an interval between at least two slits out of a plurality of slits of the upper electrode may be arbitrary, but this is preferably not smaller than 0.1 μm and not larger than 100 μm, and a width of at least one of a plurality of slits may be arbitrary, but this is preferably not smaller than 0.1 μm and not larger than 100 μm.

As described above, design values of the slit interval and the slit width are limited as a preferable mode, but a lower limit (0.1 μm) may be set in consideration of processing resolution of a laser repair machine and the like. In a case where the electrode is processed by photolithography, this is coarser and about 2 μm. Regarding an upper limit (100 μm), resolution in XY directions of a current general 3D printer (SLA) is taken into consideration. By the way, various 3D printers are commercialized, but most of them have the resolution of 100 μm.

In the 3D printer device of the first embodiment according to the present technology, the used electrode may be arbitrary, but a transparent electrode is preferable. A material forming the transparent electrode may be arbitrary, but the material forming the transparent electrode is preferably ITO, IZO, Ag nanowire, and PEDOT. This is because it is not possible to irradiate the layer to be cured with light when the metal electrode is not transparent, and an uncured portion might be generated.

However, when it comes to indispensability of the transparent electrode, there are cases where this is not indispensable. For example, in a case where the layer thickness is 10 μm and the electrode width is 2 μm, ultraviolet light applied for curing has a turn-around effect, and generated radicals move, so that a problem is not so large.

In the 3D printer device of the first embodiment according to the present technology, it is preferable that the electrode is formed in a flattening layer. This is because it is desirable that the bottom surface of the bath be flat. In order to make the structure to be manufactured according to the design value, it is desirable that the bottom surface of the bath be flat, but there are allowable cases depending on a degree. For example, in a case where the layer (for example, the resin layer) manufactured each time has a thickness of 10 μm and the thickness of the electrode is 100 nm, a step formed due to the thickness of the electrode is merely 1% of the layer thickness. In a case where flattening is performed, a material forming the flattening layer is not especially limited as long as this has a certain degree of ultraviolet transmission.

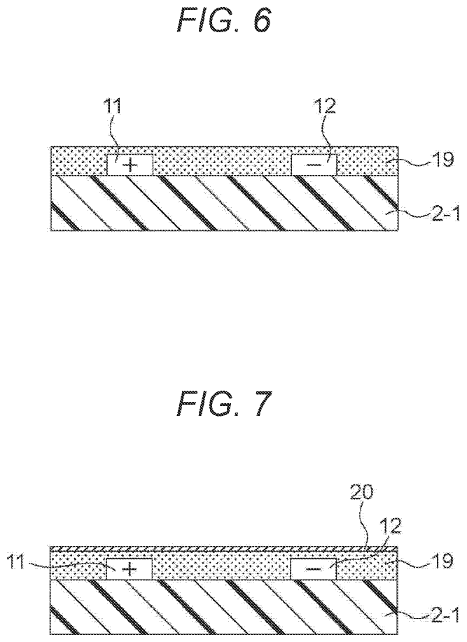

FIG. 6 is a view for illustrating that the electrode is formed in the flattening layer. As illustrated in FIG. 6, the positive electrode 11, the negative electrode 12, and a flattening layer 19 are formed on the bottom surface 2-1 of the bath 2, and the positive electrode 11 and the negative electrode 12 are formed in the flattening layer 19. Since the positive electrode 11 and the negative electrode 12 are formed in the flattening layer 19, the bottom surface (including the bottom surface 2-1 and the flattening layer 19) of the bath 2 is flat.

In the 3D printer device of the first embodiment according to the present technology, it is preferable that a surface treated layer is formed on the flattening layer. In a case of the suspension system, the layer formed on the bottom surface of the bath needs to be peeled off from the bottom surface each time. This is because the structure including the layer is entirely peeled off from the bottom surface and a gap of a next layer is created (the gap is filled with the uncured resin). It is desirable that the surface treated layer coated with fluorine and the like is formed on the bottom surface of the bath in order to prevent the bottom surface of the bath from being strongly adhered to the layer (the three-dimensional structure) at the time of peeling off.

Furthermore, the bath provided with the bottom surface having an oxygen permeable function may be used. This is a technology of slightly leaving an uncured portion on the bottom surface of the bath by intentionally introducing oxygen that inhibits radical polymerization. Note that, in addition to forming the surface treated layer on the flattening layer, it is possible that there is no flattening layer and the surface treated layer is formed directly on the electrode.

FIG. 7 is a view for illustrating that the surface treated layer is formed on the flattening layer. As illustrated in FIG. 7, the positive electrode 11, the negative electrode 12, and the flattening layer 19 are formed on the bottom surface 2-1 of the bath 2, the positive electrode 11 and the negative electrode 12 being formed in the flattening layer 19, and a surface treated layer 20 is formed on the flattening layer 19. Note that, it is preferable that the surface treated layer 20 is also flattened.

In the 3D printer device of the first embodiment according to the present technology, an active element may be installed on the used electrode. In a case of forming a region in which molecules are aligned and a non-oriented (non-aligned) region for each layer, it becomes possible to finely control the region in which the molecules are aligned and the non-oriented (non-aligned) region for each region by the active element. Furthermore, in this case, it is desirable that the active element include a permeable oxide. This is because ultraviolet light applied to the layer to be cured is shielded by the active element itself. Examples of the active element include a thin film transistor (TFT) and the like, for example. However, depending on the active element, a trouble such as a threshold voltage shift might occur due to the applied ultraviolet light. In such a case, though it depends on a size of the active element, there is a case where the active element itself is light-shielded. When the active element is small, even when this is light-shielded, ultraviolet light applied for curing has a turn-around effect, and generated radicals move, so that a problem is not so large.

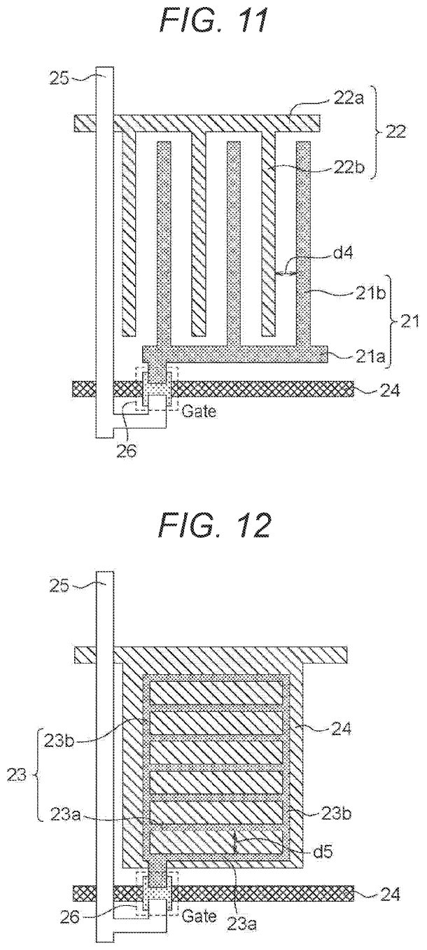

FIG. 11 is a view illustrating a configuration example of the electrode and the active element (TFT) installed on the electrode, and in further detail, FIG. 11 is a view illustrating a configuration example of the comb-shaped electrode and the active element (TFT) installed on the comb-shaped electrode.

In FIG. 11, the comb-shaped electrode includes an electrode (for example, a pixel electrode) and an electrode 22 (for example, a common electrode). The electrode 21 includes an electrode 21a (an electrode extending in a lateral direction in FIG. 11) and three electrodes 21b connected to the electrode 21a (electrodes extending upward from a connection with the electrode 21a in FIG. 11). Furthermore, the electrode 22 includes an electrode 22a (an electrode extending in a lateral direction in FIG. 11) and three electrodes 22b connected to the electrode 22a (electrodes extending downward from a connection with the electrode 22a in FIG. 11). In FIG. 11, an electrode interval between the electrode 21 (for example, the pixel electrode) and the electrode 22 (for example, the common electrode) is represented by d4.

An active element (TFT) 26 is connected to the electrode 21a of the electrode 21 (for example, the pixel electrode) and is connected to a data line 25. There is a gate on a back side on a paper surface of the active element (TFT) 26, and a gate line 24 is further arranged in the lateral direction in FIG. 11.

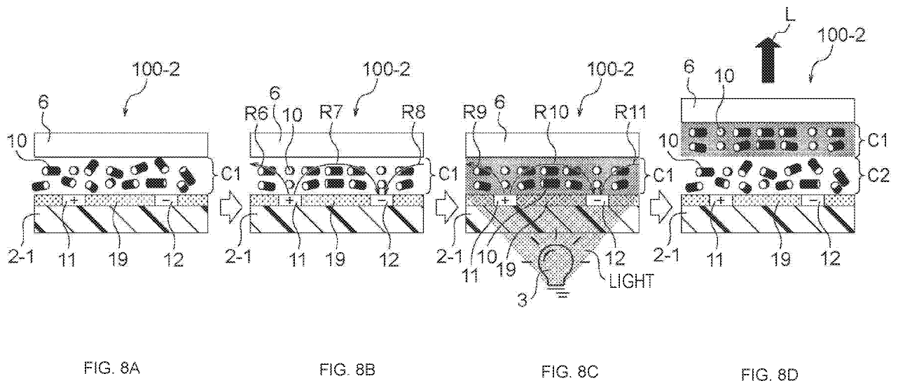

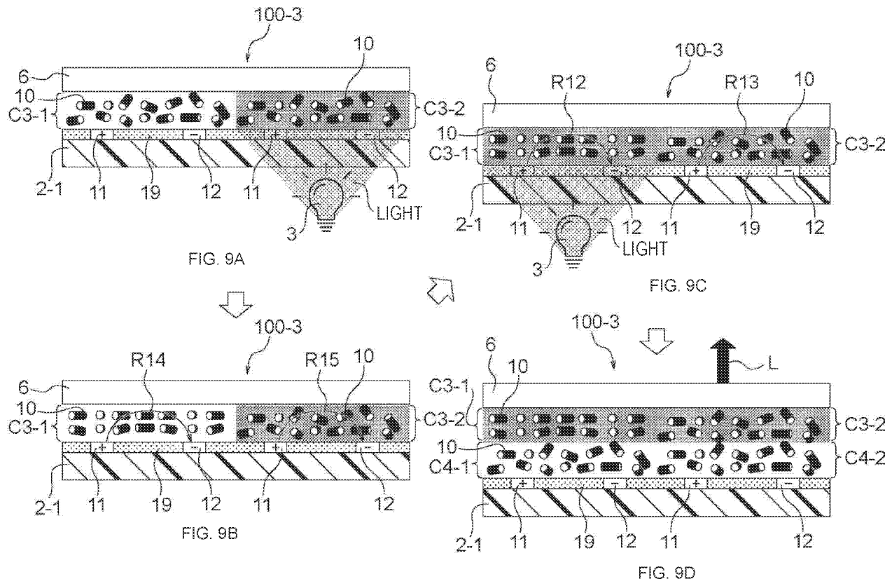

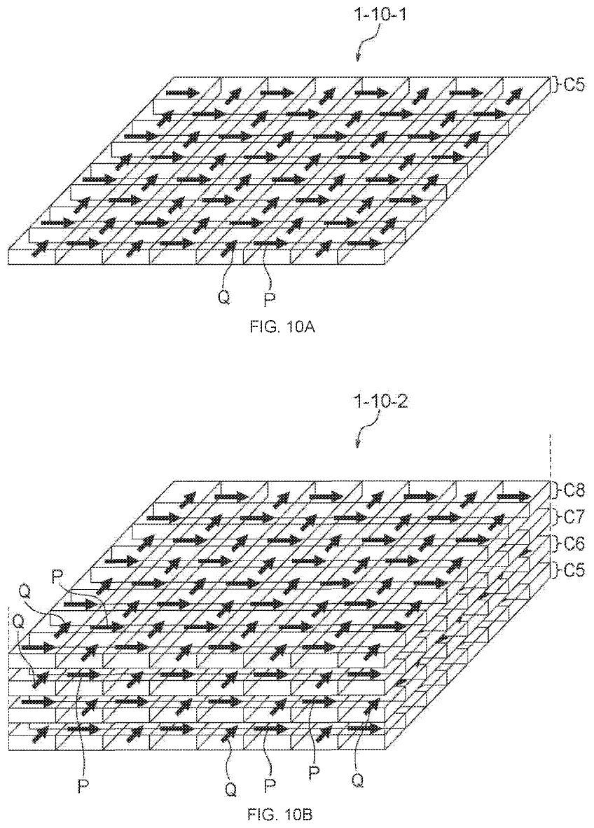

FIG. 12 is a view illustrating a configuration example of the electrode and the active element (TFT) installed on the electrode, and in further detail, FIG. 12 is a view illustrating a configuration example of the electrode having a two-layer stacked structure and the active element (TFT) installed on the electrode having the two-layer stacked structure.

In FIG. 12, the electrode having the two-layer stacked structure includes an upper electrode 23 (for example, a pixel electrode) (front side on a paper surface) and a lower electrode (for example, a common electrode) (back side on the paper surface). The upper electrode 23 is a slit-shaped electrode and includes seven slit electrodes 23a and two electrodes 23b connected to the seven slit electrodes 23a. The lower electrode 24 is a solid surface electrode. In FIG. 12, a slit interval of the slit electrodes 23a is represented by d5.

An active element (TFT) 26 is connected to the electrode 21a of the electrode 21 (for example, the pixel electrode) and is connected to a data line 25. There is a gate on a back side on a paper surface of the active element (TFT) 26, and a gate line 24 is further arranged in the lateral direction in FIG. 12.

### 3. Second Embodiment (Example of Manufacturing Method of Three-Dimensional Structure)

A manufacturing method of a three-dimensional structure of a second embodiment (an example of a manufacturing method of a three-dimensional structure) according to the present technology is a manufacturing method of a three-dimensional structure provided with forming a layer at least containing molecules and/or particles, and aligning the molecules and/or particles by applying an electric field, in which forming a layer containing molecules and/or particles and aligning the molecules and/or particles by applying an electric field are repeated a plurality of times. By the way, aligning the molecules means making directions of physical properties of the molecules uniform, and moreover, aligning the particles means making directions of physical properties of the particles uniform.

In the manufacturing method of the three-dimensional structure of the second embodiment (the example of the manufacturing method of the three-dimensional structure) according to the present technology, when applying ultraviolet light while aligning the molecules while applying the electric field by using an electrode forming the 3D printer device of the first embodiment according to the present technology, the three-dimensional structure may be formed in a state in which the molecules and/or particles in a portion to which the electric field is applied are aligned. Note that, it is also possible to apply ultraviolet light after aligning the molecules and/or particles by applying the electric field.

Depending on viscosity of a material and the like, it may take time for the molecules and/or particles to be aligned after the electric field is applied. Furthermore, in such a case, by utilizing this phenomenon, it is possible to make gradation of in-plane molecular orientation and/particle orientation by sequentially irradiating each region with ultraviolet light for curing at the same time as starting aligning the molecules and/or particles.

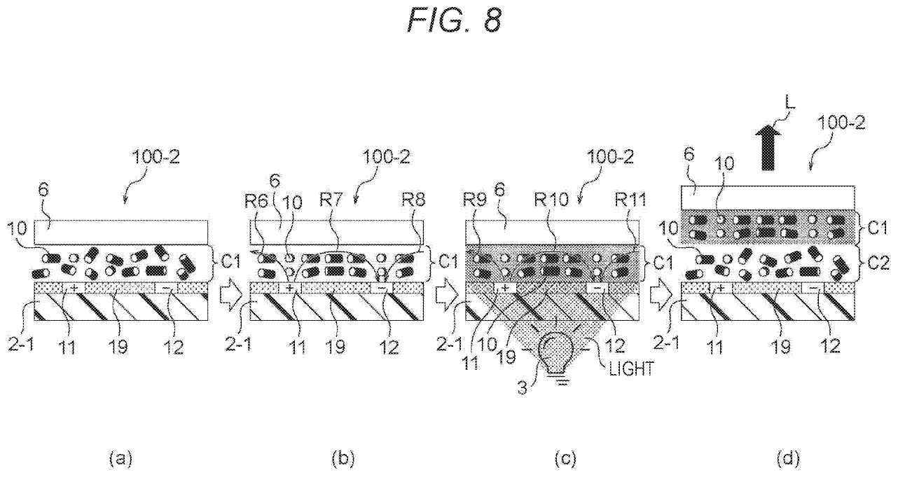

FIG. 8 is a view for illustrating the manufacturing method of the three-dimensional structure of the second embodiment according to the present technology, and in further detail, this is a view for illustrating that a three-dimensional structure (layer C1 and layer C2) is manufactured by using a 3D printer device 100-2 of the first embodiment according to the present technology. Note that, FIG. 8 may be applied not only to molecules but also to particles.

As illustrated in FIG. 8(a), a positive electrode 11 and a negative electrode 12 formed in a flattening layer 19 are arranged on a bottom surface 2-1 of a bath 2, molecules 10 are present above the positive electrode 11 and the negative electrode 12, and a stage 6 is arranged above the molecules 10. Next, as illustrated in FIG. 8(b), an electric field is applied by the positive electrode 11 and the negative electrode 12 (lines of electric force R6 to R8).

As illustrated in FIG. 8(c), while the electric field is applied (lines of electric force R9 to R11), a light source 3 applies light (for example, ultraviolet light) to the molecules 10, and the layer C1 containing the aligned molecules 10 is formed. Then, as illustrated in FIG. 8(d), the stage 6 is moved in a direction of arrow L (upward in FIG. 8(d)) and a three-dimensional structure forming liquid containing the molecules 10 for forming the layer C2 is arranged between the positive electrode 11 and negative electrode 12 and the layer C1. This is repeated to manufacture the three-dimensional structure.

In the manufacturing method of the three-dimensional structure of the second embodiment according to the present technology, the molecules and/or particles aligned by the electric field may have dielectric anisotropy. Examples of the molecules and/or particles having dielectric anisotropy include, for example, a liquid crystal material and the like.

In the manufacturing method of the three-dimensional structure of the second embodiment according to the present technology, the molecules and/or particles aligned by the electric field may express ferroelectricity. The molecules and/or particles expressing ferroelectricity are molecules and/or particles having spontaneous polarization, and examples thereof include a ferroelectric liquid crystal, an antiferroelectric liquid crystal and the like, for example.

The manufacturing method of the three-dimensional structure of the second embodiment according to the present technology may include forming a layer while performing temperature control on a resin material not yet cured out of the resin material when the layer contains the resin material. This manufacturing method is the manufacturing method of forming the layer in a state in which the resin material is heated (temperature-controlled) while providing a heating mechanism on the bath. It is heated because viscosity of the resin is high and anisotropic molecules and/or anisotropic particles might take time to move, and it is better to include a mechanism for keeping the temperature of the resin material constant because a design value and a structure match excellently. Furthermore, by raising the temperature, solubility of various molecules and particles in the resin may be increased, and more materials may be handled. Moreover, in a case of a liquid-crystalline substance, there is a case where it is possible to increase orientation of molecules and particles by using a liquid crystal phase temperature area.

In the manufacturing method of the three-dimensional structure of the second embodiment according to the present technology, it is possible to selectively cure at least a part of the layer in a state in which the electric field is not applied and cure a portion other than at least a part of the layer in a state in which the electric field is applied by using the electrode arranged on the bottom surface of the bath that accommodates the three-dimensional structure forming liquid for forming the three-dimensional structure capable of applying the electric field to the bottom surface. Note that, applying the electric field to the bottom surface means applying the electric field within a range of the stage. In other words, in general, the stage is smaller than the bottom surface of the bath, so that it is sufficient to apply the electric field to at least a portion corresponding to the size of the stage arranged on the bottom surface.

Even by the electrode that is not able to selectively apply the electric field in the formed layer, a region in which the molecules and/or particles are not oriented and a region in which the molecules and/or particles are oriented may be selectively created in the same plane. At first, the molecules and/or particles in the three-dimensional structure forming liquid before formation at the bottom of the bath are in a random state (non-oriented state). By selectively applying ultraviolet light in this state, the layer may be partially formed in a random state. In a method of selectively applying ultraviolet light, in a projector system, it is sufficient to apply only to a portion in which the layer is wanted to be formed in a random state, and in a case of a laser scanning system, it is sufficient to apply a laser only to a portion in which the layer is wanted to be formed randomly while scanning with the laser. Thereafter, the electric field is entirely applied. The anisotropic molecules and/or anisotropic particles may move by the electric field because the material is not solidified in a portion not irradiated with ultraviolet light, but the material is solidified and cannot move in a portion already formed in the random state. In a state in which the anisotropic molecules and/or anisotropic particles are oriented by application of the electric field, ultraviolet light is entirely applied or selectively applied except the solidified portion in the random state, so that the region in the oriented state and the region in the non-oriented state may be selectively created in the same plane.

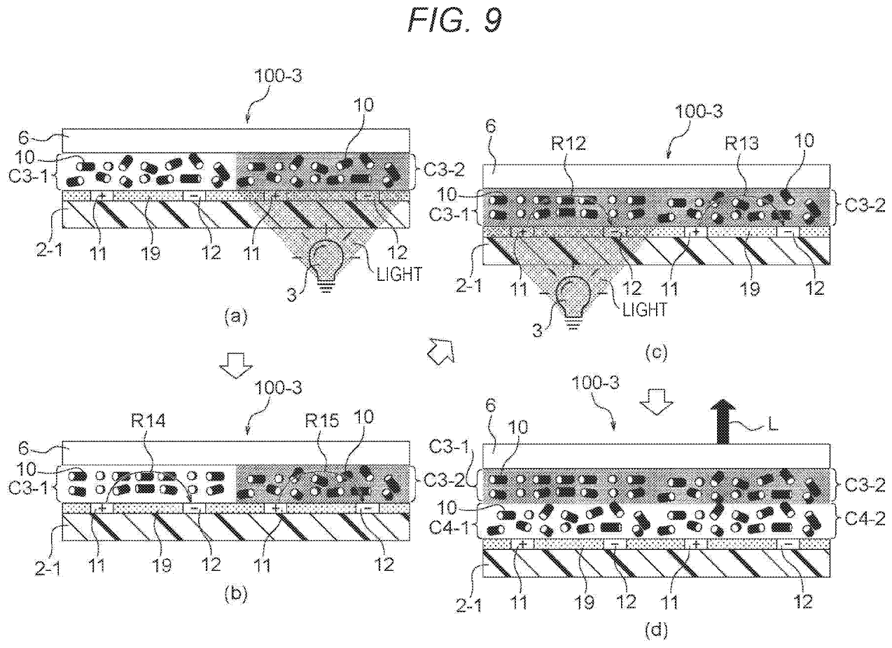

It is more specifically described with reference to FIG. 9.

FIG. 9 is a view for illustrating the manufacturing method of the three-dimensional structure of the second embodiment according to the present technology, and in further detail, this is a view for illustrating that a three-dimensional structure (layer C3 (layer C3-1 and layer C3-2) and layer C4 (layer C4-1 and layer C4-2)) is manufactured by using a 3D printer device 100-3 of the first embodiment according to the present technology. Note that, FIG. 9 may be applied not only to molecules but also to particles.

As illustrated in FIG. 9(a), two sets of the positive electrode 11 and the negative electrode 12 formed in the flattening layer 19 are arranged on the bottom surface 2-1 of the bath 2, the molecules 10 are present above the positive electrodes 11 and the negative electrodes 12, and the stage 6 is arranged above the molecules 10. By selectively applying light (for example, ultraviolet light) by the light source 3 in this state, the layer C3-2 may be partially formed in a random state of the molecules 10. Next, as illustrated in FIG. 9(b), the electric field is applied by the two sets of the positive electrode 11 and the negative electrode 12 (lines of electric force R14 to R15). The molecules 10 may move by the electric field because the material is not solidified in the portion not irradiated with ultraviolet light (portion corresponding to the layer C3-1), but the material is solidified and the molecules 10 cannot move in the portion (layer C3-2) already formed in the random state.

As illustrated in FIG. 9(c), while the electric field is applied (lines of electric force R12 and R13), the light source 3 selectively applies light (for example, ultraviolet light) to the molecules 10 aligned by the electric field, and the layer C3-1 containing the aligned molecules 10 is formed.

Then, as illustrated in FIG. 9(d), the stage 6 is moved in the direction of arrow L (upward in FIG. 9(d)) and the three-dimensional structure forming liquid for forming the layer C4-1 and the layer C4-2 containing the molecules 10 is arranged between the positive electrode 11 and negative electrode 12 and the layer C1. This is repeated to manufacture the three-dimensional structure.

In the manufacturing method of the three-dimensional structure according to the present technology, it is possible to cure an entire layer in a state in which the electric field is selectively applied to at least a part of the layer by using the electrode arranged on the bottom surface of the bath that accommodates the three-dimensional structure forming liquid for forming the three-dimensional structure capable of selectively applying the electric field to at least a part of the bottom surface.

By applying light (for example, ultraviolet light) after selectively applying the electric field by the electrode capable of selectively applying the electric field, the electrode in which the electric field is held by the electrode on which an active element, for example, a thin film transistor (TFT) is installed, it is possible to form the layer in which the molecules are oriented and/or the layer in which the particles are oriented only in the region to which the electric field is applied.

### 4. Third Embodiment (Example of Three-Dimensional Structure)

A three-dimensional structure of a third embodiment (an example of a three-dimensional structure) according to the present technology is a three-dimensional structure obtained by the manufacturing method of the three-dimensional structure of the second embodiment according to the present technology.

More specifically, the three-dimensional structure of the third embodiment (the example of the three-dimensional structure) according to the present technology is, as a first aspect, the three-dimensional structure obtained by the manufacturing method of the three-dimensional structure of the second embodiment according to the present technology, by selectively curing at least a part of a layer in a state in which an electric field is not applied and thereafter curing a portion other than at least a part of the layer in a state in which the electric field is applied by using an electrode arranged on a bottom surface of a bath that accommodates a three-dimensional structure forming liquid for forming a three-dimensional structure capable of applying the electric field to the bottom surface, the three-dimensional structure having an arbitrary molecular orientation direction and/particle orientation direction for each region of the layer. Note that, applying the electric field to the bottom surface means applying the electric field within a range of the stage. In other words, in general, the stage is smaller than the bottom surface of the bath, so that it is sufficient to apply the electric field to at least a portion corresponding to the size of the stage arranged on the bottom surface.

Furthermore, the three-dimensional structure of the first aspect of the third embodiment according to the present technology may include a non-oriented region.

The three-dimensional structure of the third embodiment (the example of the three-dimensional structure) according to the present technology is, as a second aspect, the three-dimensional structure obtained by the manufacturing method of the three-dimensional structure of the second embodiment according to the present technology, by curing an entire layer in a state in which an electric field is selectively applied to at least a part of the layer by using an electrode arranged on a bottom surface of a bath that accommodates a three-dimensional structure forming liquid for forming a three-dimensional structure capable of selectively applying the electric field to at least a part of the bottom surface, the three-dimensional structure having an arbitrary molecular orientation direction and/an arbitrary particle orientation direction for each region of the layer.

Furthermore, the three-dimensional structure of the second aspect of the third embodiment according to the present technology may include a non-oriented region.

In the portion in which the electric field is applied, it is possible to make a state in which the molecules and/or particles are aligned. Then, a molecular orientation degree and/or a particle orientation degree may be controlled by applied electric field intensity, a time in which the electric field is applied and the like.

The three-dimensional structure of the third embodiment (the example of the three-dimensional structure) according to the present technology is, as a third aspect, the three-dimensional structure obtained by the manufacturing method of the three-dimensional structure of the second embodiment according to the present technology, by selectively curing at least a part of a layer in a state in which an electric field is not applied and thereafter curing a portion other than at least a part of the layer in a state in which the electric field is applied by using an electrode arranged on a bottom surface of a bath that accommodates a three-dimensional structure forming liquid for forming a three-dimensional structure capable of applying the electric field to the bottom surface, the three-dimensional structure including a first region including a first molecule and/or a first particle, and a second region including a second molecule and/or a second particle, in which a first electric field is applied to the first region, a second electric field is applied to the second region, and a molecular orientation direction of the first molecule and/or a particle orientation direction of the first particle differs from a molecular orientation direction of the second molecule and/or a particle orientation direction of the second particle. Note that, applying the electric field to the bottom surface means applying the electric field within a range of the stage. In other words, in general, the stage is smaller than the bottom surface of the bath, so that it is sufficient to apply the electric field to at least a portion corresponding to the size of the stage arranged on the bottom surface.

Furthermore, the three-dimensional structure of the third aspect of the third embodiment according to the present technology may be the three-dimensional structure including the first region including the first molecule and/or the first particle, and the second region including the second molecule and/or the second particle, in which the first electric field is applied to the first region, the second electric field is applied to the second region, and an angle between the molecular orientation direction of the first molecule and/the particle orientation direction of the first particle and the molecular orientation direction of the second molecule and/the particle orientation direction of the second particle is substantially 90 degrees.

In the three-dimensional structure of the third aspect of the third embodiment according to the present technology, the region to which the electric field is applied (for example, the first region and the second region) may be considered as each block. At that time, it is possible to create so that the directions of adjacent molecules and/or particles are different. The three-dimensional structure of the third aspect of the third embodiment according to the present technology may be manufactured depending on the intensity of the electric field, the time in which this is applied, and arrangement of the electrodes.

The three-dimensional structure of the third embodiment (the example of the three-dimensional structure) according to the present technology is, as a fourth aspect, the three-dimensional structure obtained by the manufacturing method of the three-dimensional structure of the second embodiment according to the present technology, by curing an entire layer in a state in which an electric field is selectively applied to at least a part of the layer by using an electrode arranged on a bottom surface of a bath that accommodates a three-dimensional structure forming liquid for forming a three-dimensional structure capable of selectively applying the electric field to at least a part of the bottom surface, the three-dimensional structure including a first region including a first molecule and/a first particle, and a second region including a second molecule and/second particle, in which a first electric field is applied to the first region, a second electric field is applied to the second region, and a molecular orientation direction of the first molecule and/a particle orientation direction of the first particle differs from a molecular orientation direction of the second molecule and/a particle orientation direction of the second particle.

Furthermore, the three-dimensional structure of the fourth aspect of the third embodiment according to the present technology may be the three-dimensional structure including the first region including the first molecule and/the first particle, and the second region including the second molecule and/or the second particle, in which the first electric field is applied to the first region, the second electric field is applied to the second region, and an angle between the molecular orientation direction of the first molecule and/the particle orientation direction of the first particle and the molecular orientation direction of the second molecule and/or the particle orientation direction of the second particle is substantially 90 degrees.

In the three-dimensional structure of the fourth aspect of the third embodiment according to the present technology, the region to which the electric field is applied (for example, the first region and the second region) may be considered as each block. At that time, it is possible to create so that the directions of adjacent molecules and/or particles are different. The three-dimensional structure of the fourth aspect of the third embodiment according to the present technology may be manufactured depending on the intensity of the electric field, the time in which this is applied, and arrangement of the electrodes.

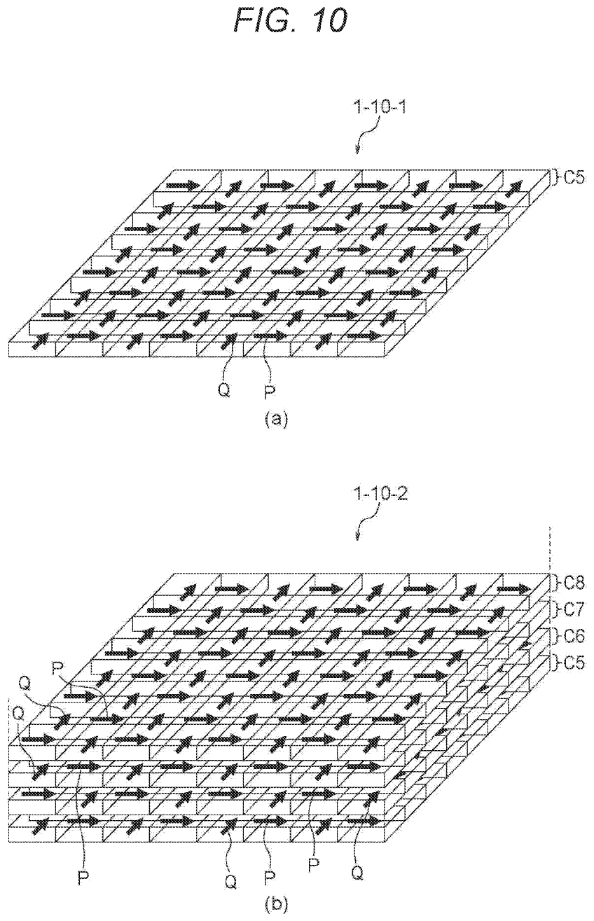

FIG. 10 is a view illustrating a configuration example of the three-dimensional structure of the fourth aspect of the third embodiment according to the present technology. Note that, FIG. 10 may be applied not only to molecules but also to particles.

FIG. 10(a) illustrates a layer C5, one layer of a three-dimensional structure 1-10-1 of the fourth aspect of the third embodiment according to the present technology. As illustrated in FIG. 10(a), in the first molecule and the second molecule contained in the layer C5, an angle between a molecular orientation direction P of the first molecule and a molecular orientation direction Q of the second molecule is substantially 90 degrees.

FIG. 10(b) illustrates layers C5 to C8, four layers of a three-dimensional structure 1-10-2 of the fourth aspect of the third embodiment according to the present technology. As illustrated in FIG. 10(b), in the first molecule and the second molecule contained in each layer of the layers C5 to C8, an angle between a molecular orientation direction P of the first molecule and a molecular orientation direction Q of the second molecule is substantially 90 degrees.

The present technology is not limited to each of the above-described embodiments and various modifications may be made without departing from the gist of the present technology.

Furthermore, the present technology may have the following configurations.

[1]

A 3D printer device at least provided with:

a three-dimensional structure forming liquid for forming a three-dimensional structure;

a bath that accommodates the three-dimensional structure forming liquid; and

an electrode, in which

the electrode is arranged on a bottom surface of the bath.

[2]

The 3D printer device according to [1], in which

at least two electrodes are arranged on the bottom surface of the bath, and

an electric field is generated between the at least two electrodes.

[3]

The 3D printer device according to [2], in which an interval between the at least two electrodes is not smaller than 0.1 μm and not larger than 100 μm.

[4]

The 3D printer device according to [2] or [3], in which an electrode width of each of the at least two electrodes is not smaller than 0.1 μm and not larger than 100 μm.

[5]

The 3D printer device according to any one of [2] to [4], in which the at least two electrodes are comb-shaped electrodes.

[6]

The 3D printer device according to [1], in which

at least two electrode layers are arranged on the bottom surface of the bath, and

an electric field is generated between the at least two electrode layers.

[7]

The 3D printer device according to [6], in which

the at least two electrode layers are stacked, and

an upper electrode layer is patterned.

[8]

The 3D printer device according to [7], in which

the upper electrode layer has a slit structure,

the slit structure includes a plurality of slits, and

an interval between at least two slits of the plurality of slits is not smaller than 0.1 μm and not larger than 100 μm.

[9]

The 3D printer device according to [8], in which a width of a slit of the upper electrode layer is not smaller than 0.1 μm and not larger than 100 μm.

[10]

The 3D printer device according to any one of [1] to [9], in which the electrode is a transparent electrode.

[11]

The 3D printer device according to any one of [1] to [10], provided with:

a flattening layer, in which

the electrode is formed in the flattening layer.

[12]

The 3D printer device according to [11], further provided with: a surface treated layer formed on the flattening layer.

[13]

The 3D printer device according to any one of [1] to [12], in which an active element is installed on the electrode.

[14]

A manufacturing method of a three-dimensional structure provided with:

forming a layer at least containing molecules and/or particles; and

aligning the molecules and/or particles by applying an electric field, in which

the forming the layer containing the molecules and/or particles and the aligning the molecules and/particles by applying the electric field are repeated a plurality of times.

[15]

The manufacturing method of a three-dimensional structure according to [14], in which the molecules and/or the particles have ferroelectricity.

[16]

The manufacturing method of a three-dimensional structure according to [14] or [15], in which the molecules and/or the particles express ferroelectricity.

[17]

The manufacturing method of a three-dimensional structure according to any one of [14] to [16], in which

the layer contains a resin material,

the manufacturing method provided with:

forming a layer while performing temperature control on the resin material not yet cured out of the resin material.

[18]

The manufacturing method of a three-dimensional structure according to any one of [14] to [17], provided with:

with an electrode arranged on a bottom surface of a bath that accommodates a three-dimensional structure forming liquid for forming a three-dimensional structure, the electrode capable of applying an electric field to the bottom surface,

selectively curing at least a part of the layer in a state in which the electric field is not applied, and thereafter curing a portion other than the at least a part of the layer in a state in which the electric field is applied.

[19]

The manufacturing method of a three-dimensional structure according to any one of [14] to [17], provided with:

with an electrode arranged on a bottom surface of a bath that accommodates a three-dimensional structure forming liquid for forming a three-dimensional structure, the electrode capable of selectively applying an electric field to at least a part of the bottom surface,

curing an entire layer in a state in which the electric field is selectively applied to at least a part of the layer.

[20]

A three-dimensional structure obtained by the manufacturing method according to [18], the three-dimensional structure having an arbitrary molecular orientation direction and/or an arbitrary particle orientation direction for each region of the layer.

[21]

The three-dimensional structure according to [20], provided with: a non-oriented region.

[22]

A three-dimensional structure obtained by the manufacturing method according to [19], the three-dimensional structure having an arbitrary molecular orientation direction and/or an arbitrary particle orientation direction for each region of the layer.

[23]

The three-dimensional structure according to [22], provided with: a non-oriented region.

[24]

A three-dimensional structure obtained by the manufacturing method according to [18],

the three-dimensional structure provided with:

a first region including a first molecule and/or a first particle, and a second region including a second molecule and/or a second particle, in which

a first electric field is applied to the first region,

a second electric field is applied to the second region, and

a molecular orientation direction of the first molecule and/or a particle orientation direction of the first particle is different from a molecular orientation direction of the second molecule and/or a particle orientation direction of the second particle.

[25]

The three-dimensional structure according to [24], in which an angle between the molecular orientation direction of the first molecule and/or the particle orientation direction of the first particle and the molecular orientation direction of the second molecule and/or the particle orientation direction of the second particle is substantially 90 degrees.

[26]

The three-dimensional structure according to [24] or [25], provided with: a non-oriented region.

[27]

A three-dimensional structure obtained by the manufacturing method according to [19],

the three-dimensional structure provided with:

a first region including a first molecule and/or a first particle, and a second region including a second molecule and/or a second particle, in which

a first electric field is applied to the first region,

a second electric field is applied to the second region, and

a molecular orientation direction of the first molecule and/or a particle orientation direction of the first particle is different from a molecular orientation direction of the second molecule and/or a particle orientation direction of the second particle.

[28]

The three-dimensional structure according to [27], in which an angle between the molecular orientation direction of the first molecule and/or the particle orientation direction of the first particle and the molecular orientation direction of the second molecule and/or the particle orientation direction of the second particle is substantially 90 degrees.

[29]

The three-dimensional structure according to [27] or [28], provided with: a non-oriented region.

[30]

A three-dimensional structure obtained by the manufacturing method according to [14], the three-dimensional structure having an arbitrary molecular orientation direction and/or an arbitrary particle orientation direction for each region of the layer.

[31]

The three-dimensional structure according to [30], provided with: a non-oriented region.

[32]

A three-dimensional structure obtained by the manufacturing method according to [14],

the three-dimensional structure provided with:

a first region including a first molecule and/or a first particle, and a second region including a second molecule and/or a second particle, in which

a first electric field is applied to the first region,

a second electric field is applied to the second region, and

a molecular orientation direction of the first molecule and/or a particle orientation direction of the first particle is different from a molecular orientation direction of the second molecule and/or a particle orientation direction of the second particle.

[33]

The three-dimensional structure according to [32], in which an angle between the molecular orientation direction of the first molecule and/or particle orientation of the first particle and the molecular orientation direction of the second molecule and/or particle orientation of the second particle is substantially 90 degrees.

[34]

The three-dimensional structure according to any one of [20] to [33], in which the molecules and/or the particles have dielectric anisotropy.

[35]

The three-dimensional structure according to any one of [20] to [34], in which the molecules and/or the particles express ferroelectricity.

[36]

The three-dimensional structure according to any one of [20] to [35], in which

the layer contains a resin material,

the three-dimensional structure provided with forming a layer while performing temperature control on the resin material not yet cured out of the resin material.

### REFERENCE SIGNS LIST

(1-1, 1-10-1, 1-10-2) Three-dimensional structure

2 Bath

3 Light source

3-1 Laser

4-1 Galvanometer mirror

5 Three-dimensional structure forming liquid

6 Stage

7 Vertical motion drive device

7-1 Vertical motion drive unit

10 Molecule

11 Electrode (positive electrode)

12 Electrode (negative electrode)

16 (16-1, 16-2) Electrode layer (upper layer, positive electrode)

17 Electrode layer (lower layer, negative electrode)

18 Insulating layer

19 Flattening layer

20 Surface treated layer

100 (100-1, 100-2, 100-3) 3D printer device

C (C1, C2, C3-1, C3-2, C4-1, C4-2, C5, C6, C7, C8) Layer

R (R1, R2, R3, R4, R5, R6, R7, R8, R9, R10, R11, R12, R13, R14, R15) Line of force

P Molecular orientation direction of first molecule

Q Molecular orientation direction of second molecule.

1. A 3D printer device at least comprising:
a three-dimensional structure forming liquid for forming a three-dimensional structure;
a bath that accommodates the three-dimensional structure forming liquid; and
an electrode, wherein
the electrode is arranged on a bottom surface of the bath.

2. The 3D printer device according to claim 1, wherein
at least two electrodes are arranged on the bottom surface of the bath, and
an electric field is generated between the at least two electrodes.

3. The 3D printer device according to claim 2, wherein an interval between the at least two electrodes is not smaller than 0.1 μm and not larger than 100 μm.

4. The 3D printer device according to claim 2, wherein an electrode width of each of the at least two electrodes is not smaller than 0.1 μm and not larger than 100 μm.

5. The 3D printer device according to claim 2, wherein the at least two electrodes are comb-shaped electrodes.

6. The 3D printer device according to claim 1, wherein
at least two electrode layers are arranged on the bottom surface of the bath, and
an electric field is generated between the at least two electrode layers.

7. The 3D printer device according to claim 6, wherein
the at least two electrode layers are stacked, and
an upper electrode layer is patterned.

8. The 3D printer device according to claim 7, wherein
the upper electrode layer has a slit structure,
the slit structure includes a plurality of slits, and
an interval between at least two slits of the plurality of slits is not smaller than 0.1 μm and not larger than 100 μm.

9. The 3D printer device according to claim 8, wherein a width of a slit of the upper electrode layer is not smaller than 0.1 pm and not larger than 100 μm.

10. The 3D printer device according to claim 1, wherein the electrode is a transparent electrode.

11. The 3D printer device according to claim 1, comprising:
a flattening layer, wherein
the electrode is formed in the flattening layer.

12. The 3D printer device according to claim 11, further comprising: a surface treated layer formed on the flattening layer.

13. The 3D printer device according to claim 1, wherein an active element is installed on the electrode.

14. A manufacturing method of a three-dimensional structure comprising:
forming a layer at least containing molecules and/or particles; and
aligning the molecules and/or particles by applying an electric field, wherein
the forming the layer containing the molecules and/or particles and the aligning the molecules and/particles by applying the electric field are repeated a plurality of times.

15. The manufacturing method of a three-dimensional structure according to claim 14, wherein the molecules and/or the particles have dielectric anisotropy.

16. The manufacturing method of a three-dimensional structure according to claim 14, wherein the molecules and/or the particles express ferroelectricity.

17. The manufacturing method of a three-dimensional structure according to claim 14, wherein
the layer contains a resin material,
the manufacturing method comprising:
forming a layer while performing temperature control on the resin material not yet cured out of the resin material.

18. The manufacturing method of a three-dimensional structure according to claim 14, comprising:
with an electrode arranged on a bottom surface of a bath that accommodates a three-dimensional structure forming liquid for forming a three-dimensional structure, the electrode capable of applying an electric field to an entire bottom surface,
selectively curing at least a part of the layer in a state in which the electric field is not applied, and thereafter curing a portion other than at least a part of the layer in a state in which the electric field is applied.

19. The manufacturing method of a three-dimensional structure according to claim 14, comprising:
with an electrode arranged on a bottom surface of a bath that accommodates a three-dimensional structure forming liquid for forming a three-dimensional structure, the electrode capable of selectively applying an electric field to at least a part of the bottom surface,
curing an entire layer in a state in which the electric field is selectively applied to at least a part of the layer.

20. A three-dimensional structure obtained by the manufacturing method according to claim 18, the three-dimensional structure having an arbitrary molecular orientation direction and/or an arbitrary particle orientation direction for each region of the layer.

21. The three-dimensional structure according to claim 20, comprising: a non-oriented region.

22. A three-dimensional structure obtained by the manufacturing method according to claim 19, the three-dimensional structure having an arbitrary molecular orientation direction and/or an arbitrary particle orientation direction for each region of the layer.

23. The three-dimensional structure according to claim 22, comprising: a non-oriented region.

24. A three-dimensional structure obtained by the manufacturing method according to claim 18,
the three-dimensional structure comprising:
a first region including a first molecule and/or a first particle, and a second region including a second molecule and/or a second particle, wherein
a first electric field is applied to the first region,
a second electric field is applied to the second region, and
a molecular orientation direction of the first molecule and/or a particle orientation direction of the first particle is different from a molecular orientation direction of the second molecule and/or a particle orientation direction of the second particle.

25. The three-dimensional structure according to claim 24, wherein an angle between the molecular orientation direction of the first molecule and/or the particle orientation direction of the first particle and the molecular orientation direction of the second molecule and/or the particle orientation direction of the second particle is substantially 90 degrees.

26. A three-dimensional structure obtained by the manufacturing method according to claim 19,
the three-dimensional structure comprising:
a first region including a first molecule and/or a first particle, and a second region including a second molecule and/or a second particle, wherein
a first electric field is applied to the first region,
a second electric field is applied to the second region, and
a molecular orientation direction of the first molecule and/or a particle orientation direction of the first particle is different from a molecular orientation direction of the second molecule and/or a particle orientation direction of the second particle.

27. The three-dimensional structure according to claim 26, wherein an angle between the molecular orientation direction of the first molecule and/or the particle orientation direction of the first particle and the molecular orientation direction of the second molecule and/or the particle orientation direction of the second particle is substantially 90 degrees.
